(19) United States
(12) Patent Application Publication
(10) Pub. No.: US 2025/0329889 A1
(43) Pub. Date: Oct. 23, 2025

(54) METHODS FOR SMART BATTERY ASSEMBLY

(71) Applicants: CPS Technology Holdings LLC, New York, NY (US); Clarios Germany GmbH & Co. KG, Hannover (DE)

(72) Inventors: Torsten GRETH, Wunstorf (DE); Gerardus C. ZWEGERS, Alamosa, CO (US); Bruce D. MACLACHLAN, Seneca, SC (US); Gary GRAMER, Alexandria, KY (US); Jeffrey L. TROXEL, Menomonee Falls, WI (US); Jason D. FUHR, Sussex, WI (US); Arunraj VARATHARAJAH, Menomonee Falls, WI (US); Rengaraj BALAKRISHNAN, Raleigh, NC (US); Joseph E. LIEDHEGNER, Wauwatosa, WI (US)

(21) Appl. No.: 19/122,016

(22) PCT Filed: Oct. 18, 2023
(86) PCT No.: PCT/US2023/077181

§ 371 Date: Apr. 17, 2025

Related U.S. Application Data
(60) Provisional application No. 63/417,174, filed on Oct. 18, 2022.
(60) Provisional application No. 63/433,975, filed on Dec. 20, 2022.
(60) Provisional application No. 63/433,964, filed on Dec. 20, 2022.
(60) Provisional application No. 63/434,634, filed on Dec. 22, 2022.

(51) Int. Cl. H01M 50/516; H01M 10/42; H01M 50/15; H01M 50/507; H01M 50/54

(52) U.S. Cl. CPC H01M 50/516; H01M 10/4257; H01M 50/15; H01M 50/507; H01M 50/54; H01M 2010/4271

(57) ABSTRACT

A method for assembling a battery is described. The battery has a plurality of battery cells, a post assembly, a plurality of posts, and a plurality of straps. The method includes coupling each strap of the plurality of straps to one battery cell of the plurality of battery cells, coupling each post of the plurality of posts to one strap of the plurality of straps, where each one of the coupled posts is electrically coupled to one battery cell corresponding to the one strap, and performing an intercell coupling between at least a pair of battery cells of the plurality of battery cells by coupling a pair of posts of the plurality of posts.

### TECHNICAL FIELD

This disclosure relates to batteries and in particular to manufacturing and/or assembly of a smart battery to facilitate battery performance/failure monitoring.

### BACKGROUND

As battery technology evolves, the demand for improved power sources such as energy storage modules for vehicles continues to grow. Existing battery systems, for example lead acid battery systems, typically offer limited access to performance and failure monitoring. More specifically, existing lead acid battery systems may not be capable of providing one or more battery parameters (e.g., usable to determine performance and/or predict/monitor failure) of one or more battery cells of the lead acid battery system. In other words, it is difficult for existing lead acid battery systems to provide information about vital components, such as the state of health of the individual battery cells. Accordingly, the state of health of battery cells cannot be monitored and/or determined, thus hindering the ability to predict upcoming battery failure or the onset of failure.

### SUMMARY

Some embodiments advantageously provide a method of manufacturing and/or assembling a battery (e.g., using inter-cell welding and/or pre-stuffing, using post based inter-cell connection and/or pre-stuffing, using inter-cell welding and stuffing, and/or using electrofusion (EF) welding) such as to provide an arrangement monitor the state of health of individual battery cells of the battery. In some embodiments, the method includes coupling one or more posts to one or more battery cells, where the one or more battery cells have been electrically and/or physically connected, e.g., using inter-cell welding. In some other embodiments, the battery cells are assembled using pre-stuffing. In one embodiment, the posts may be electrically connected to a lead assembly and/or a battery management system (BMS), e.g., to determine/measure at least one parameter associated with the battery (e.g., smart battery) and/or battery cells, such as cell voltage, current, temperature, etc. In some embodiments, the battery cells, inter-cell connections, the BMS, lead assembly, posts, and/or other components are assembled and/or manufactured in the battery, e.g., without having to change one or more specifications of the battery.

According to one aspect, a method for assembling a battery is described. The battery has a plurality of battery cells, a post assembly, a plurality of posts, and a plurality of straps. The method includes coupling each strap of the plurality of straps to one battery cell of the plurality of battery cells, coupling each post of the plurality of posts to one strap of the plurality of straps, where each one of the coupled posts is electrically coupled to one battery cell corresponding to the one strap, and performing an intercell coupling between at least a pair of battery cells of the plurality of battery cells by coupling a pair of posts of the plurality of posts.

In some embodiments, the coupling of each strap of the plurality of straps to one battery cell of the plurality of battery cells is performed using a first cast-on-strapping (COS) process.

In some other embodiments, the coupling of each post of the plurality of posts to one strap of the plurality of straps is performed using a second COS process.

In some embodiments, the method further includes, prior to coupling each strap to one battery cell and coupling each post to one strap, one of stuffing the battery cells and pre-stuffing the battery cells.

In some other embodiments, the performing of the intercell coupling includes welding the pair of posts.

In some embodiments, the performing of the intercell coupling includes electrically coupling the pair of posts to one strap of the plurality of straps.

In some other embodiments, the performing of the intercell coupling includes coupling one strap of the plurality of straps to the pair of battery cells.

In some embodiments, the battery includes at least an intercell connector, and the performing of the intercell coupling includes coupling the intercell connector to the pair of posts.

In some other embodiments, the battery further includes a cover. The cover includes a pair of openings electrically coupled via the intercell connector, and the method further includes inserting the pair of posts through the pair of openings, the inserted pair of posts being electrically coupled via the intercell connector.

In some embodiments, the battery is a lead acid battery.

According to another aspect, a method for assembling a battery is described. The battery has a plurality of battery cells, a plurality of posts, and a plurality of straps. The method includes coupling each strap of the plurality of straps to one battery cell of the plurality of battery cells. The coupling of each strap of the plurality of straps to one battery cell of the plurality of battery cells is performed using a first cast-on-strapping (COS) process. The method further includes coupling each post of the plurality of posts to one strap of the plurality of straps. Each one of the coupled posts is electrically coupled to one battery cell corresponding to the one strap. Coupling of each post of the plurality of posts to one strap of the plurality of straps is performed using a second COS process. The method further includes performing an intercell coupling between at least a pair of battery cells of the plurality of battery cells by coupling a pair of posts of the plurality of posts.

In some embodiments, the method further includes, prior to coupling each strap to one battery cell and coupling each post to one strap, one of stuffing the battery cells and pre-stuffing the battery cells.

In some other embodiments, the performing of the intercell coupling includes welding the pair of posts.

In some embodiments, the performing of the intercell coupling includes electrically coupling the pair of posts to one strap of the plurality of straps.

In some other embodiments, the performing of the intercell coupling includes coupling one strap of the plurality of straps to the pair of battery cells.

In some embodiments, the battery includes at least an intercell connector, and the performing of the intercell coupling includes coupling the intercell connector to the pair of posts.

In some other embodiments, the battery further includes a cover. The cover includes a pair of openings electrically coupled via the intercell connector, and the method further includes inserting the pair of posts through the pair of openings. The inserted pair of posts is electrically coupled via the intercell connector.

According to one aspect, a method for assembling a battery is described. The battery has a plurality of battery cells, a plurality of posts, a plurality of straps, and an intercell connector. The method includes coupling each strap of the plurality of straps to one battery cell of the plurality of battery cells. The coupling of each strap of the plurality of straps to one battery cell of the plurality of battery cells is performed using a first COS process. In addition, the method includes coupling each post of the plurality of posts to one strap of the plurality of straps. Each one of the coupled posts is electrically coupled to one battery cell corresponding to the one strap. The coupling of each post of the plurality of posts to one strap of the plurality of straps is performed using a second COS process. Further, the method includes performing an intercell coupling between at least a pair of battery cells of the plurality of battery cells by coupling a pair of posts of the plurality of posts. The performing of the intercell coupling includes at least one of welding the pair of posts, electrically coupling the pair of posts to one strap of the plurality of straps, coupling one strap of the plurality of straps to the pair of battery cells, and coupling the intercell connector to the pair of posts.

In some embodiments, the method further includes, prior to coupling each strap to one battery cell and coupling each post to one strap, one of stuffing the battery cells and pre-stuffing the battery cells.

In some other embodiments, the battery further includes a cover. The cover includes a pair of openings electrically coupled via the intercell connector. The method further includes inserting the pair of posts through the pair of openings. The inserted pair of posts is electrically coupled via the intercell connector.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows an example battery and one or more components of the example battery according to the principles of the present disclosure;

FIG. 2 shows an example battery (e.g., exploded view) and one or more components of the example battery according to the principles of the present disclosure;

FIG. 3 shows an example post assembly according to the principles of the present disclosure;

FIG. 4 shows one or more steps of an example battery assembly process using inter-cell welding and/or pre-stuffing according to the principles of the present disclosure;

FIG. 5 shows a flowchart of another example battery assembly process according to the principles of the present disclosure;

FIG. 6 shows an example element according to the principles of the present disclosure;

FIG. 7 shows an example assembly of electrodes, posts, and straps according to the principles of the present disclosure;

FIG. 8 shows example components of the example battery according to the principles of the present disclosure;

FIG. 9 shows example inter-cell connections according to the principles of the present disclosure; and

FIG. 10 shows a flowchart of an example battery assembly process according to the principles of the present disclosure;

FIG. 11 shows a flowchart of another example battery assembly process according to the principles of the present disclosure;

FIG. 12 shows an example post assembly including posts according to the principles of the present disclosure;

FIG. 13 shows an example stuffing process according to the principles of the present disclosure;

FIG. 14 shows an example pre-stuffing process according to the principles of the present disclosure;

FIG. 15 shows a flowchart of another example battery assembly process according to the principles of the present disclosure;

FIG. 16 shows an example battery assembly process according to the principles of the present disclosure;

FIG. 17 shows a flowchart of another example battery assembly process according to the principles of the present disclosure;

FIG. 18 shows a flowchart of another example battery assembly process according to the principles of the present disclosure;

FIG. 19 shows a flowchart of an example battery assembly process according to the principles of the present disclosure; and

FIG. 20 shows a flowchart of another example battery assembly process according to the principles of the present disclosure.

### DESCRIPTION

As battery technology evolves, there is a need to provide improved power sources, and more efficient and cost-effective methods for manufacturing and/or assembling such power sources as compared to conventional systems and methods.

Accordingly, embodiments described and shown herein provide a method of manufacturing and/or assembling a smart battery, e.g., using inter-cell welding and/or pre-stuffing and/or stuffing and/or an intercell connector, etc.

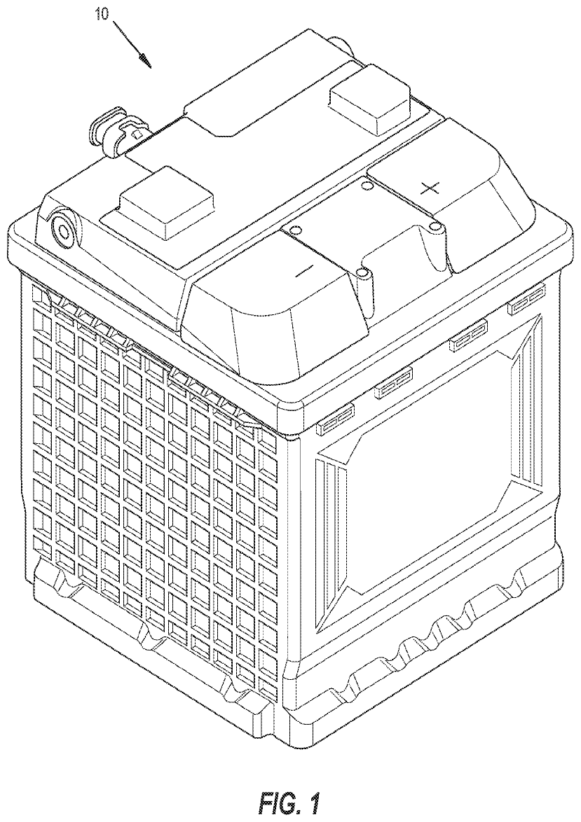

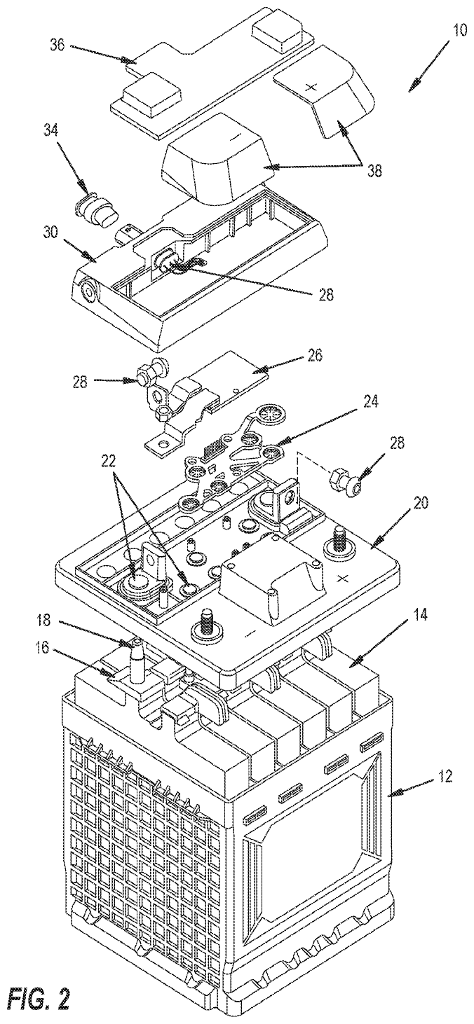

FIGS. 1 and 2 show an example battery (e.g., a lead acid battery having a smart Absorbent Glass Mat (AGM) battery assembly) and one or more components of the example battery. Battery 10 may include at least one of the following: a case 12 (which may be made of from a resin or any other suitable material), one or more battery cells 14, a post assembly 15 (e.g., Cast-On-Strap (COS) post assembly), strap 16, one or more posts 18 (e.g., a terminal post, a mini-post), a first cover 20, one or more bushings 22 (e.g., a U1 bushing, a mini-bushing), a lead assembly 24 (e.g., a lead frame), a battery management system 26 (e.g., including a board), one or more fasteners 28, a second cover 30, a wiring harness 32, a vehicle connector 34, a third cover 36, and one or more terminal caps 38. Post assembly 15 may include one or more posts 18 and/or one or more straps 16. In some embodiments, post assembly 15 comprises one strap 16 for each post 18 (e.g., coupled together). In some other embodiments, a strap 16 may be coupled to more than one post 18.

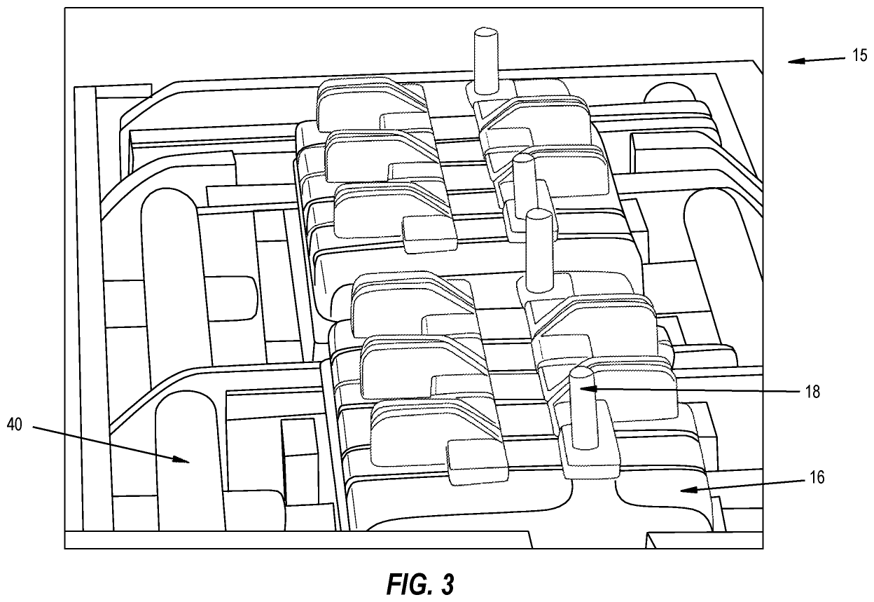

FIG. 3 shows an example post assembly 15 according to the principles of the present disclosure. Post assembly 15 may be formed/manufactured using a COS process, which may include strap 16 and posts 18 (e.g., welded, formed in a unitary construction in conjunction with the post assembly 15, etc.) and/or jig box 40. In some embodiments, jig box 40 is used to manufacture post assembly 15 and is not part of the manufactured post assembly 15.

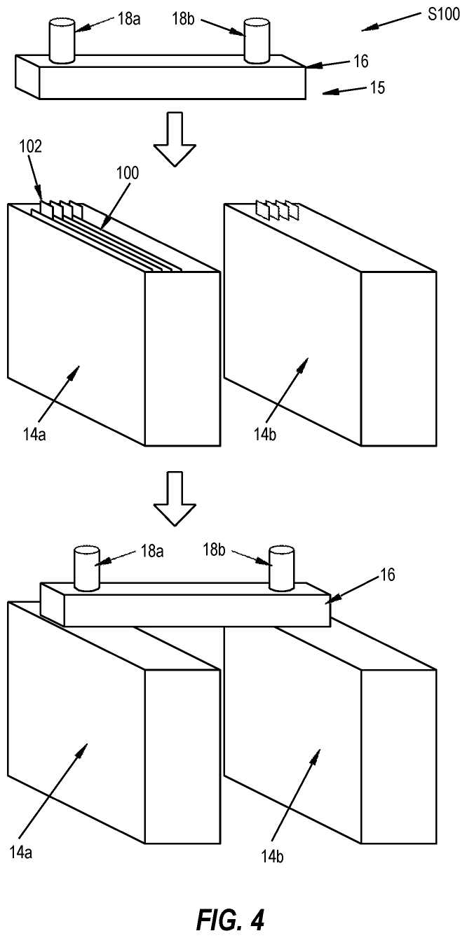

FIG. 4 shows one or more steps of an example battery assembly process using inter-cell welding and/or pre-stuffing according to the principles of the present disclosure. At step S100, post assembly 15, which may include one or more posts 18 (e.g., posts 18a, 18b) a strap 16, is coupled to one or more battery cells 14 (e.g., battery cells 14a, 14b). The battery cells 14 may be pre-stuffed (i.e., filled with one or more components such as one or more plates 100 and/or other components, e.g., prior to the post assembly 15 being coupled to the battery cells 14). A plate 100 may comprise a cathode plate, anode plate, a positive/negative grid, a separator, etc. Pre-stuffing may include covering and/or sealing the battery cell. A portion of the plates 100 (e.g., plate tabs 102) may be exposed (i.e., protruding from the battery cell). The plates tabs 102 of each battery cell 14 may be interconnected, e.g., prior to the post assembly 15 being coupled to the battery cells 14.

In this example, a first battery cell 14a is shown including a plurality of plates 100 and/or a plurality of plate tabs 102. Each plate tab 102 may be coupled to a corresponding plate 100 and provide one or more electrical connections with the corresponding plate 100. Each plate 100 of the plurality of plates 100 and/or each plate tab 102 of the plurality of plate tabs 102 may be interconnected to a corresponding plate 100 and/or plate tab 102, respectively. Interconnecting may include physically and/or electrically coupling (e.g., welding). Interconnecting may include using a plate connector to couple plates 100 and/or plate tabs 102. Interconnected plates 100 and/or plate tabs 102 may form a single unit such as a plate group and/or a plate tab group. Further, a second battery cell 14b is also shown. The second battery cell 14 may be covered as part of the pre-stuffing step. Although the first battery cell 14a is shown uncovered (i.e., for ease of understanding), the first battery cell 14a is not limited as such and may be covered as the second battery cell 14b.

Coupling post assembly 15 to the first and second battery cells 14a, 14b (and/or more battery cells) may include coupling post assembly 15 (e.g., directly, indirectly, physically, electrically) to one or more plates 100 and/or one or more plate tabs 102. Further, coupling post assembly 15 to the first and second battery cells 14a, 14b may include coupling a post 18 (e.g., directly, indirectly, physically, electrically) to a corresponding battery cell 14 and/or to the corresponding plurality of plates 100 and/or to the corresponding plurality of plate tabs 102. For example, post 18a may be coupled to: battery cell 14a and/or plate(s) 100 of battery cell 14a and/or plate tab(s) 102 of battery cell 14a. Similarly, post 18b may be coupled to: battery cell 14b and/or plate(s) 100 of battery cell 14b and/or plate tab(s) 102 of battery cell 14b. In other words, by coupling post assembly 15 and/or posts 18 to battery cells 14, an inter-cell coupling (e.g., a connection) may be formed such as between plates 100 which may have the same (or different) polarity in the first battery cell 14a and in the second battery cell 14b. The coupling (and/or inter-cell coupling) may comprise welding and/or any other coupling process/step.

In some embodiments, pre-stuffing refers to the insertion (e.g., partial insertion) of plurality of plates 100 (and/or plate tabs 102) into a case 12 such as container (e.g., plastic box) before connecting lugs of the plates 100 with a cast on strap process (COS). In some other embodiments, on AGM batteries, a compression frame may be used to size the plurality of plates 100 into the container. In one or more embodiments, partially insertion may refer to inserting such that a portion is not inserted (i.e., another portion is inserted) such as that ¼ of the plurality of plates 100 extends outside of the case 12.

In some other embodiments, a jig box 40 may be used and may refer to a tool part of a COS machine/process that carries the case 12 such as container (e.g., plastic box) with the pre-stuffed plurality of plates through the process steps of the cast on strap process.

In one or more embodiments, a jig box 40 (e.g., a COS jig box) may be arranged to locate a product/component (e.g., plurality of plates pre-stuffed in the container). The location may be an accurate location/position determined during the process steps of the cast on strap process. The jig box 40 may further serve as a carrier to transport a product/component through the process steps performed by a COS machine.

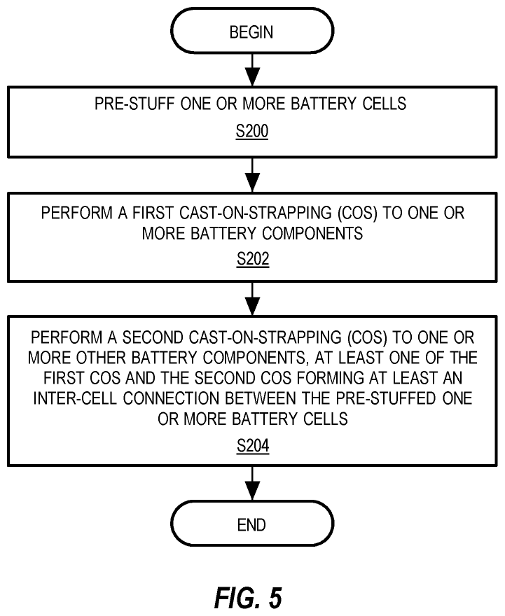

FIG. 5 shows another example assembly process (i.e., a method) of a battery 10 according to the principles of the present disclosure. The method includes one or more of: pre-stuffing (Block S102) one or more battery cells; performing (Block S104) a first cast-on-strapping (COS) to one or more battery components such as post assembly 15 and one or more battery cells 14; and performing (Block S106) a second cast-on-strapping (COS) to one or more other battery components such as posts 18 (e.g., mini-posts) and/or post assembly 15, at least one of the first COS and the second COS forming an inter-cell connection between the pre-stuffed one or more battery cells.

In some embodiments, any one of the first COS and the second COS includes casting straps to the pre-stuffed one or more battery cells 14 (e.g., books).

In some other embodiments, the method further includes performing enveloping and/or stacking of battery cells 14.

In an embodiment, the pre-stuffing is performed using a pre-stuffing tool. A pre-stuffing tool may be arranged/configured to arrange and fix one or more books (e.g., plurality of plates, battery cell) in a frame to position the one or more books above a case 12. Another tool comprising pushers may be arranged to press the books into the case 12. In a pre-stuffing process, the books may be moved/inserted into the container (e.g., not completely into the container). That is, the insertion may be partial, e.g., to assure the plates are extend outside of the case 12 such as to enable the cast on strap process in this arrangement in the COS machine to be performed.

In another embodiment, the first COS is performed using jig boxes 40 for containers (i.e., cases 12) with books (i.e., battery cells 14).

In some embodiments, the second COS is performed using a mold (e.g., having a predetermined pitch such as a small pitch).

In some other embodiments, the battery cells 14 (i.e., pre-stuffed battery cells) are inserted (i.e., in-boxed) in the case 12.

In an embodiment, a height of each post 18 is tested. The test may be performed with probes such as mechanical probes, e.g., to detect the height (of the posts over the level of the case 12). The height may also be measured with a camera or three dimensional scanner (e.g., contactless).

In another embodiment, the battery 10 further includes a post assembly 15 and one or more posts 18, the one or more battery components associated with the first COS include post assembly 15 and one or more battery cells 14, and the one or more other battery components associated with the second COS include posts 18 (e.g., mini-posts) and/or post assembly 15, the first COS and the second COS electrically connecting at least one of the post assembly 15 and the one or more posts 18 to the one or more battery cells 14.

In another embodiment, inter-cell welding is performed at least by welding the post assembly 15 to one or more battery cells 14.

In some embodiments, the inter-cell welding is performed using weld jaws.

In some other embodiments, the method includes aligning each post 18 with at least one other post 18.

In an embodiment, each post 18 is aligned with at least one other post 18 using an alignment tool. The alignment tool may have a gage plate with bushings that align the posts by moving the alignment gage over the assembly. Further, the alignment tool may have a gripper (e.g., automatic gripper or multiple grippers) that aligns the posts to the predetermined position.

In some embodiments, the battery 10 further includes a first cover 20 that is coupled to the case 12.

In some other embodiments, coupling the first cover 20 to the case 12 includes performing at least one of:
sealing the first cover 20 to the case 12; and
welding (e.g., tungsten inert gas (TIG) welding, flame welding) the first cover 20 to the case 12.

In one or more embodiments, the method further includes connecting (e.g., physically, electrically) a portion of battery cell 14 (e.g., strap) to a bushing of the first cover 20. The connecting may comprise using automatic post burn (APB).

In an embodiment, battery 10 further includes a lead assembly 24 and a battery management system 26 configured to determine and/or measure at least one battery cell parameter. The method further includes: electrically coupling the one or more posts 18 to the lead assembly 24; and electrically coupling the lead assembly 24 to the battery management system 26.

In another embodiment, the method further includes at least one of testing a terminal height; testing battery height; and performing a leak test on the battery 10.

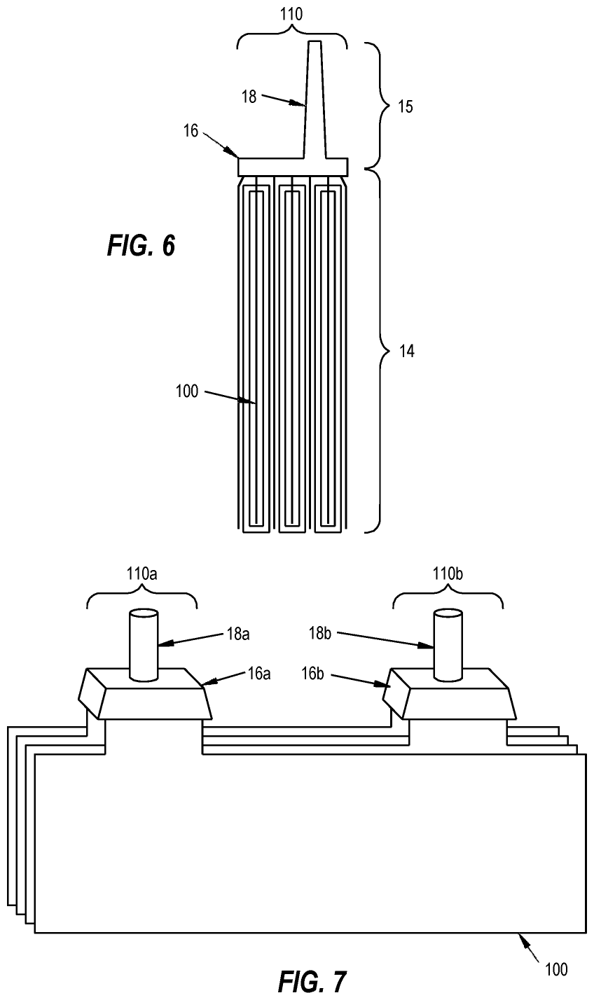

FIG. 6 shows an example element 110 of battery 10 according to the principles of the present disclosure. More specifically, a battery cell 14, a post assembly 15 (comprising a strap 16 and a post 18, Cast-On-Strap (COS) post assembly), and an element 110 are shown. Strap 16 with post 18 may casted onto battery cell 14 to form element 110, which may include plates 100. The casting may occur after the book (battery cell 14) is pre-stuffed (i.e., partially inserted) in a battery case (or container). Element 110 may comprise or be a book or stack. However, element 110 is not limited to books or stacks and can comprise or take other structural forms, e.g., wound coils.

FIG. 7 an example assembly of plates 100, straps 16, and posts 18 according to the principles of the present disclosure. Each element 110 has straps 16 including a post 18 for each polarity. More specifically, post assembly 15a comprises strap 16a coupled to post 18a. Post assembly 15 a is coupled to one or more plates 100 and may have a first polarity (e.g., positive). Similarly, post assembly 15b comprises strap 16b coupled to post 18b. Post assembly 15b is coupled to one or more plates 100 and may have a second polarity (e.g., negative).

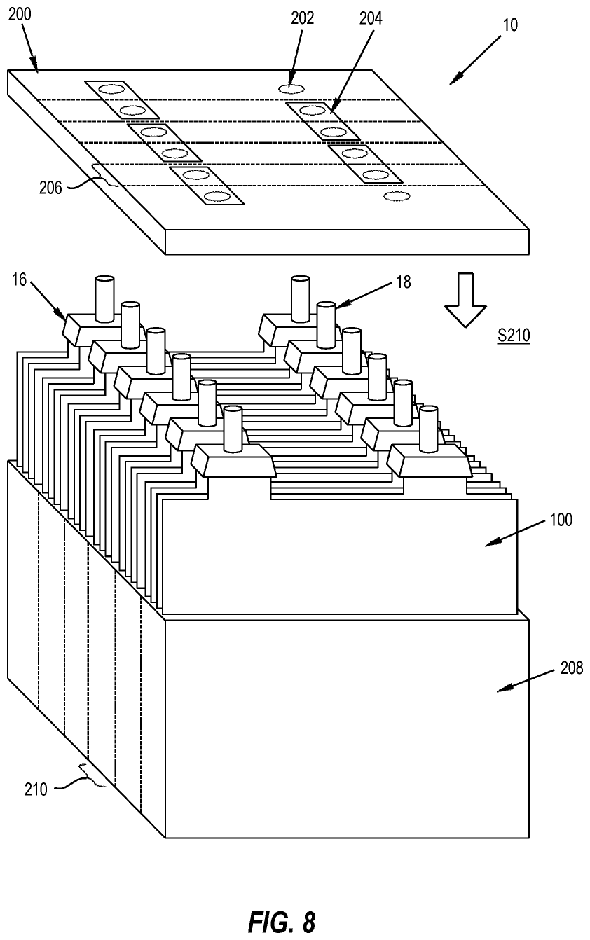

FIG. 8 shows example components of the example battery 10. Battery 10 may comprise a straps 16, posts 18, cover 200, and case 208. Case 208 (e.g., container, housing) may include one or more partitions 210 (e.g., six partitions), a group of plates 100 (e.g., a set of electrodes corresponding to a first polarity, and another set of electrodes corresponding to a second polarity), one or more post assemblies 15 (i.e., strap 16 and post 18). Each partition 210 may be arranged to receive one or more plates 100 and two (or any other quantity of) post assemblies 15 (i.e., strap 16 and post 18). Straps 16 (e.g., lead connectors) and/or post 18 may be arranged to receive and couple to a lug. Cover 200 may comprise one or more partitions 206 (e.g., six partitions), where each partition 206 corresponds to one partition 210. Further, cover 200 may comprise one or more openings 202 (e.g., where each may include a bushing 22), at least one opening 202 is arranged to receive and couple a corresponding post 18 (e.g., a terminal post, cell post, etc.) to the cover 200, via a bushing 22. In addition, cover 200 may comprise one or more intercell connector 204 (i.e., conductor plate, busbar, intercell connector, etc.) arranged to electrically couple posts 18 of at least two neighboring partitions 206. Intercell connector 204 may be integrated with cover 200. Thus, cover 200 may be placed over the plurality of posts 18 and straps 16 and the posts 18 inserted via a corresponding opening 202 (and bushing 22). In a nonlimiting example, one terminal post 18 is electrically coupled to the cover 200, and another terminal post 18 is coupled to the cover (e.g., but not electrically connected to the cover). The remaining posts 18 may be connected in pairs such as to form an intercell connection via intercell connector 204 of cover 200. Step S210 may include inserting plates 100, straps 16, posts 18 in a corresponding partition 210. Step S210 may also include coupling cover 200 to case 208, where posts 18 protrude through openings 202 and extend away from cover 200, thereby establishing an intercell electrical connection via intercell connector 204. In some embodiments, cover 200 may be the same as or similar to first cover 20, and case 208 may be the same as or similar to case 12.

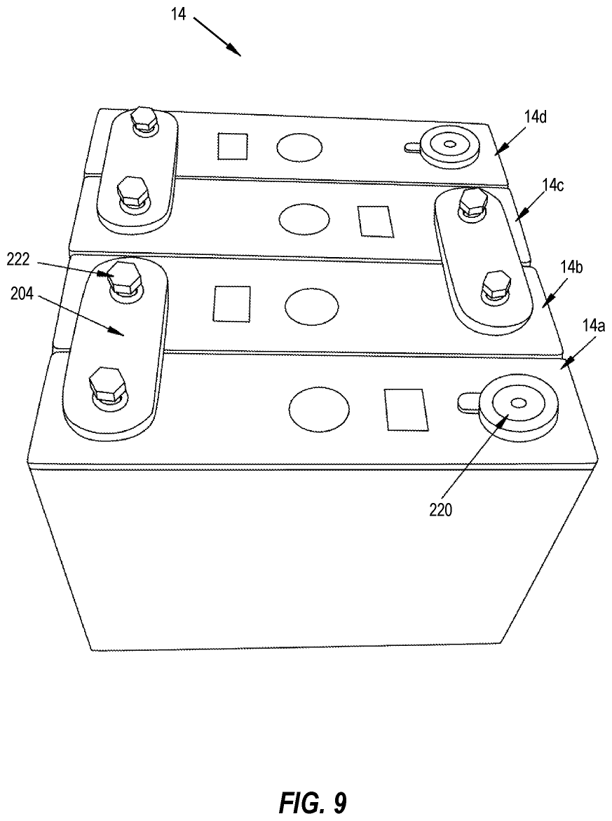

FIG. 9 shows example inter-cell connections according to the principles of the present disclosure. More specifically, a plurality of battery cells 14 (i.e., battery cells 14a, 14b, 14c, 14c) are shown. Each battery cell 14 may be comprised in a container or book and may correspond to a partition 206 and/or partition 210. Each one of the battery cells 14 (may comprise an element 110) and may comprise at least one battery cell connector 220 (e.g., comprising a post and/or a bushing), which may be arranged to electrically and/or physically connect to any component of the battery cell 14. For example, battery cell connector 220 may be arranged to physically/electrically connect (e.g., couple to) one or more plates 100. In some embodiments, battery cell connector 220 may comprise or be connected to a post 18 coupled to bushing 22. In some embodiments, battery cell connector 220 may be a terminal connection or a cell connection. Further, battery cell connector 220 may be arranged to receive and/or electrically and/or physically connect (e.g., couple to) one or more intercell connectors 204. Battery cell connector 52 may also be arranged to receive and/or physically/or electrical connect (e.g., couple) to a fastener 222. The intercell connector 204 may include one or more openings arranged to receive one or more fasteners 222 and be arranged to interconnect (e.g., physically and/or electrically connect) one or more battery cells 14. For example, battery cells 14a, 14b may be interconnected via intercell connector 204 which may be received by two battery cell connectors 220, where each battery cell connector 220 corresponds to a battery cell 14. Intercell connector 204 may be fastened using fastener 222 and the corresponding battery cell connector 220 (e.g., under intercell connector 204).

That is, by using battery cell connector 220 and/or intercell connector 204 and/or fastener 222, two or more battery cells 14 (e.g., battery cells 14a, 14b) may be interconnected, which may create and/or maintain an electrical connection between battery cells 14. Any one of battery cell connector 220, intercell connector 204, and fastener 222 may be arranged to be releasably coupled to any component of battery 10, e.g., battery cells 14 (and/or any of its components), battery cell connector 220, intercell connector 204, fastener 222, post assembly 15, posts 18 (e.g., mini-posts), one or more bushings 22, lead assembly 24, a battery management system 26, etc.

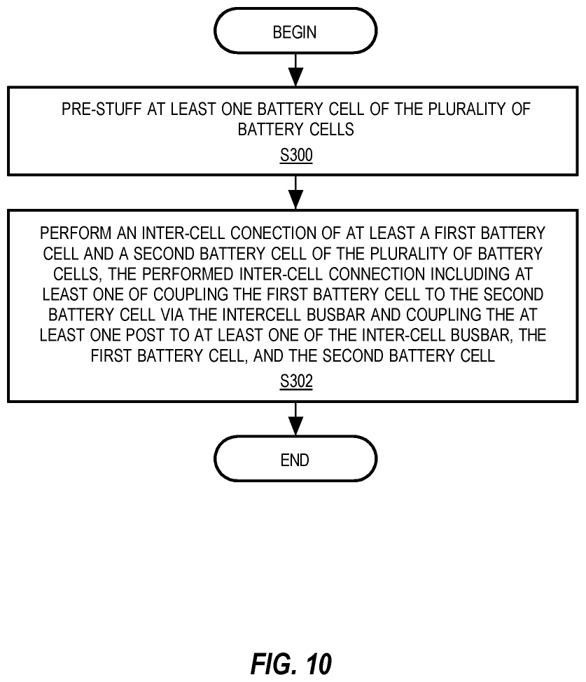

FIG. 10 is a flowchart of an example assembly process (i.e., a method) of a battery 10 according to the principles of the present disclosure. The battery 10 includes an inter-cell busbar 44, at least one post 18, a plurality of battery cells 50. The method includes one or more of pre-stuffing (Block S102) at least one battery cell of the plurality of battery cells 14 and performing (Block S104) an inter-cell connection of at least a first battery cell 14a and a second battery cell 14b of the plurality of battery cells 14. The performed inter-cell connection including at least one of coupling the first battery cell 14a to the second battery cell 14b via the inter-cell busbar (i.e., intercell connector 204) and coupling the at least one post 18 to at least one of the inter-cell busbar (i.e., intercell connector 204), the first battery cell 14a, and the second battery cell 14b.

In some embodiments, the battery 10 further comprises a first battery cell connector 220a and a second battery cell connector 220b, and each one of the first battery cell 14a and the second battery cell 14b comprise a plurality of plates 100 (e.g., electrodes), the method further comprising coupling the first battery cell connector 220a to the plurality of plates 100 of the first battery cell 14a; and coupling the second battery cell connector 220b to the plurality of plates 100 of the second battery cell 14b.

In some other embodiments, the method further includes coupling the first battery cell connector 220a to the intercell connector 204; and coupling the second battery cell connector 220b to the intercell connector 204.

In an embodiment, the battery 10 further includes a first fastener 222a and a second fastener 222b. The method further includes coupling the first fastener 22a to the inter-cell connector 204 and the first battery cell connector 220a at least by fastening the first fastener 222a to the first battery cell connector 220a; and coupling the second fastener 222b to the intercell connector 204 and second battery cell connector 220b at least by fastening the second fastener 222b to the second battery cell connector 220b. The fastening of the first and second fasteners 222a, 222b secures the intercell connector 204 to each one of the first and second battery cells 14a, 14b and forms a connection between the first and second battery cells 14a, 14b.

In another embodiment, coupling the at least one post 18 to at least one of the intercell connector 204, the first battery cell 14a, and the second battery cell 14b further includes coupling the at least one post 18 to at least one of the first battery cell connector 220a and a second battery cell connector 220b.

In some embodiments, the battery 10 further includes a cover 200 comprising at least one bushing 22 coupled to the intercell connector 204, where the at least one post 18 is coupled to the at least one bushing 22 at least to perform the intercell connection.

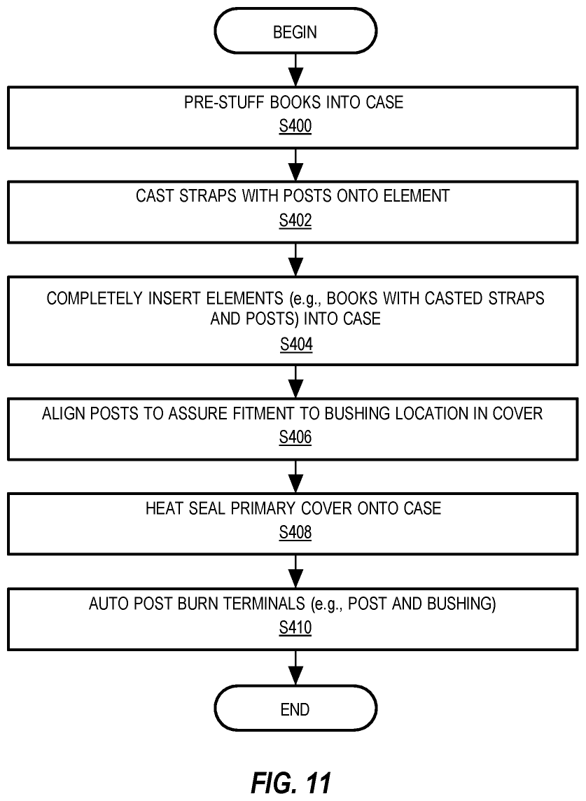

FIG. 11 is a flowchart of another example assembly process (i.e., a method) of a battery 10 according to the principles of the present disclosure. At step S400, books (i.e., battery cells 14) are pre-stuffed into case 208 (e.g., inserted as shown in FIG. 8). At step S402, the method includes casting straps 16 with posts 18 onto element 110. At step S404, the method includes inserting elements 110 into (e.g., completely inserting in, stuffing, etc.) case 208. At step S406, posts 18 are aligned to ensure fitment to bushing location in cover 200. At step S408, the method includes heat sealing cover 200 (e.g., primary cover) onto case 208, and at step S410, the method includes performing an automatic post burn of terminals (e.g., posts 18 and/or bushings 42).

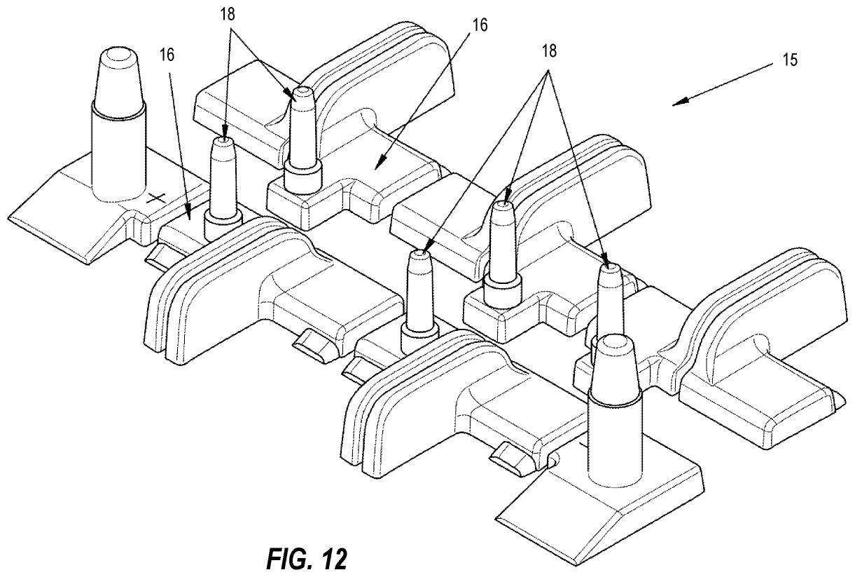

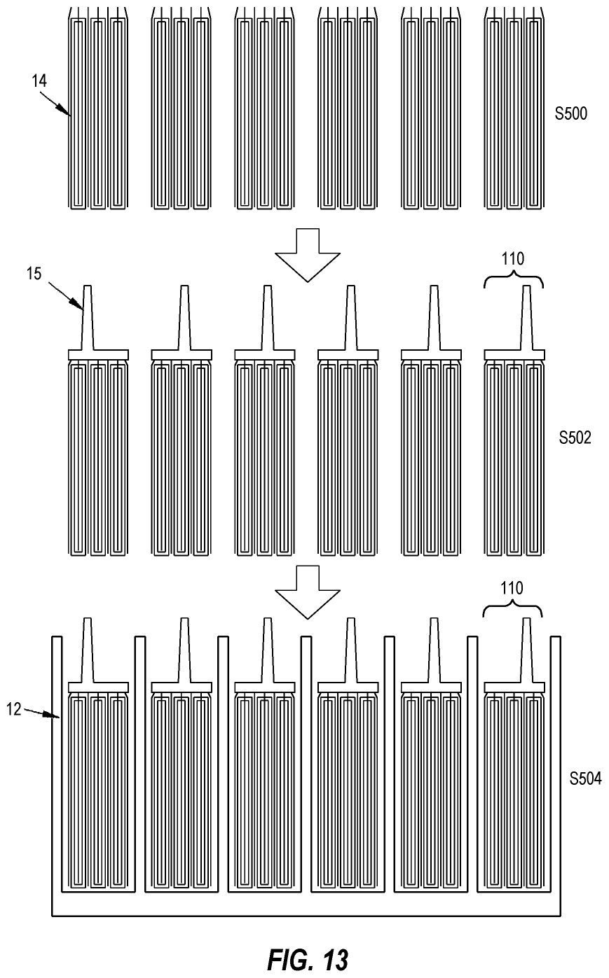

FIG. 12 shows an example post assembly 15 including straps 16 and posts 18 according to the principles of the present disclosure. More specifically, post assembly 15 comprises at least one strap 16 and one post 18. A process may be performed to manufacture post assembly 15. The process may be the process shown in FIG. 5 (or any other process) and include casting straps 16 with posts 18. The process may be a cast-on-strap (COS) process used for grouping and joining elements of battery 10. Post assembly 15 may be arranged to be received by (and/or connect to) battery cells 14. That is, when the process is performed, post assembly 15 comprises one or more posts 18 formed or assembled as one or more pieces that are usable for connecting each post 18 to one or more corresponding battery cells 14, e.g., as shown in FIG. 2. Further, posts 18 are arranged to be connectable to lead assembly 24 and/or BMS 26, e.g., such that the BMS 26 is electrically connected to the battery cells 14 via the posts 18 of post assembly 15 and configured to determine at least one parameter of battery cells 14.

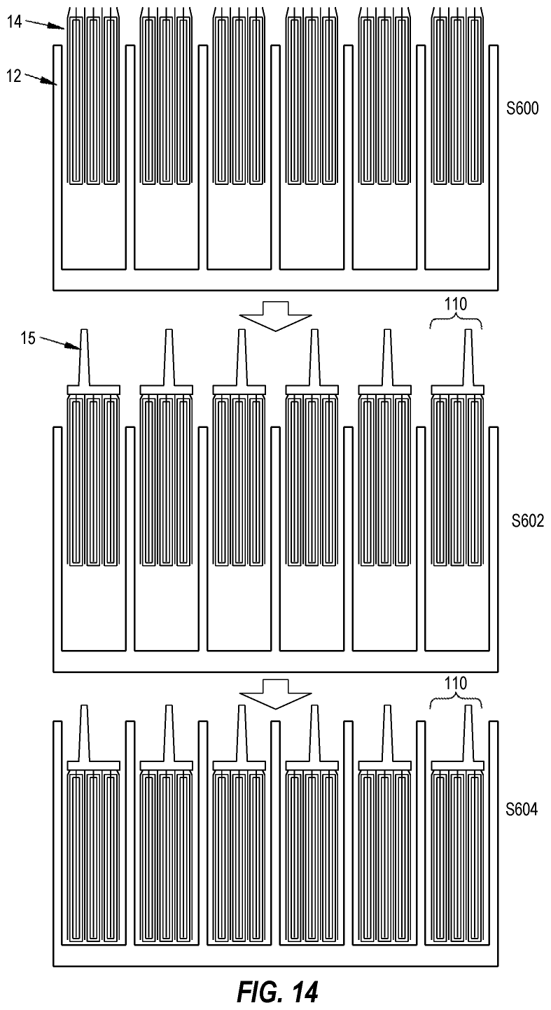

FIG. 13 shows an example stuffing process, e.g., casting straps to books without pre-stuffing. At step S500, a set of battery cells 14 (e.g., set of n books) is arranged, e.g., in a gripper of a machine. At step S502, post assembly 15 are cast (e.g., books are coupled to casted straps) and/or arranged in the gripper machine. At step S504, a set of n elements 110 (e.g., books or battery cells 14 with cast straps) are inserted in case 12, e.g., where an entirety of each battery cell 14 (e.g., book) is within a compartment of case 12. In some embodiments, an entirety of each element 110 is within a compartment of case 12. That is, stuffing may refer to completely inserting battery cells (books) within case 12.

FIG. 14 shows an example pre-stuffing process, e.g., casting straps to books with pre-stuffing. At step S600, a set of battery cells 14 (e.g., set of n books) is arranged, e.g., in a gripper of a machine, and pre-stuffed (e.g., partially inserted in case 12). At step S602, post assemblies 15 are cast (e.g., books are coupled to casted straps 16) where elements 110 are partially inserted in case 12 and/or arranged in the gripper machine. At step S604, a set of n elements 110 (e.g., books with cast straps) may be fully inserted in case 12, e.g., where an entirety of each battery cell 14 (e.g., book) is within a compartment of case 12. In some embodiments, an entirety of each element 110 is within a compartment of case 12. That is, steps S600 and S602 may refer to pre-stuffing, and step S604 may refer to completely inserting books within case 12, i.e., stuffing.

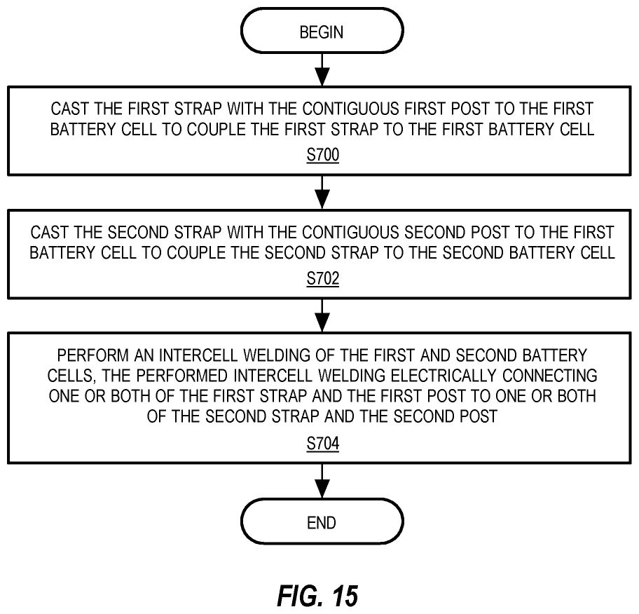

FIG. 15 is a flowchart of another example assembly process (i.e., a method) of a battery 10 according to the principles of the present disclosure. The battery 10 includes a first battery cell 14a, a second battery cell 14a, a first strap 16a and a first post 18a contiguous with the first strap 16a, and a second strap 16b and second post 18b contiguous with the second strap 16b. The method includes one or more of casting (Block S700) the first strap 16a with the contiguous first post 18a to the first battery cell 14a to couple the first strap 16a to the first battery cell 14a; casting (Block S702) the second strap 16b with the contiguous second post 18b to the second battery cell 14b to couple the second strap 16b to the second battery cell 14b; and performing (Block S704) an intercell welding of the first and second battery cells 14a, 14b. The performed intercell welding electrically connecting one or both of the first strap 16a and the first post 18a to one or both of the second strap 16a and the second post 18b.

In some embodiments, the casting of the one or more straps is performed using an overflow mold having a predetermined pitch.

In some other embodiments, the battery 10 further comprises a case 12, and the casting of the one or more straps 16 is performed using a jig box 40 for the case 12.

In an embodiment, the method further includes stuffing the plurality of battery cells 14.

In some embodiments, one or more of the following steps are performed: enveloping of battery components such as battery cells 14, stacking battery components such as battery cells 14, inboxing (i.e., inserting of) the battery cells 14 and/or post assembly 15 in case 12, testing the height of posts 18, aligning posts, sealing first cover 20, second cover 30, third cover 36, and/or caps 38 to another battery component, testing terminal height and/or battery height, and performing leak tests.

In a nonlimiting example, straps 16 and posts 18 are casted in one step. A set of plates 100 with lugs (e.g., electrodes with lugs) are connected to each other by a cast on strap process (e.g., casting of by post assembly 15). Then, the battery cells 14 (e.g., plate sets, books) including the casted straps 16 to the corresponding posts 18 (casted in one step) is inserted (stuffed) into case 12 (e.g., a container). An intercell welding is performed where two or more battery cells 14 are interconnected via at least a portion of the post assembly 15. The first cover 20 is sealed to case 12, where at least a portion of the posts 18 protrudes out of first cover 20. Lead assembly 24 is connected to each protruding post 18 and connected to the BMS 26. That is, the BMS 26 is electrically connected to the battery cells 14 via post assembly 15 to perform at least one action associated with a parameter of the battery cells 14 such as measuring voltage of each battery cell 14.

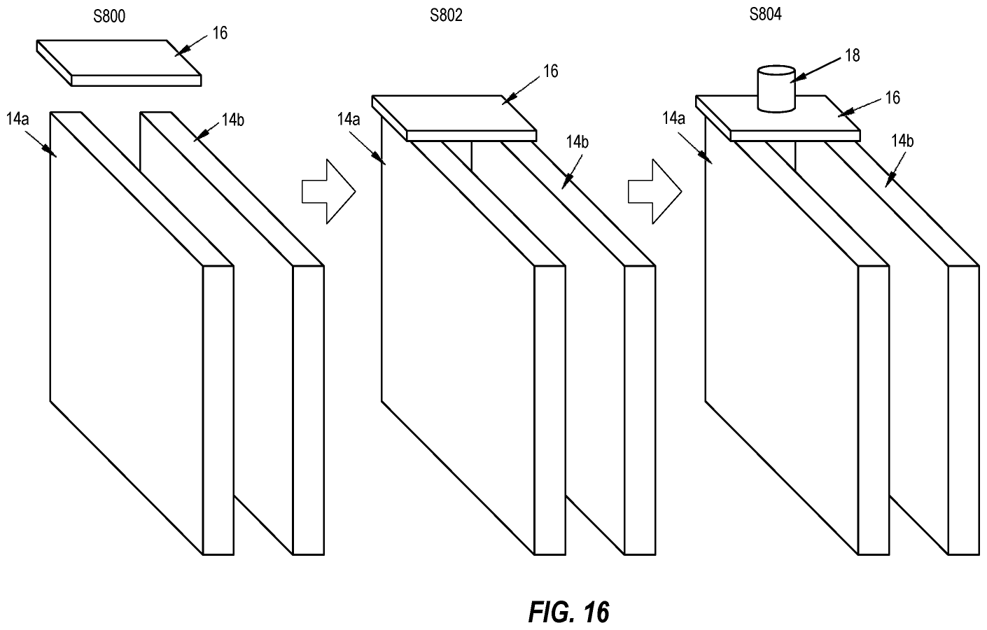

FIG. 16 shows an example battery assembly process according to the principles of the present disclosure. At step S800, strap 16 is placed over two battery cells 14a, 14b. At step S802, an inter-cell welding is performed, i.e., welding of the strap 16 to both battery cells 14a, 14b. At step S804, post 18 is coupled (e.g., welded) to strap 16. That is, the example process allows welding of straps 16 to battery cells 14 before posts 18 are coupled to straps 16.

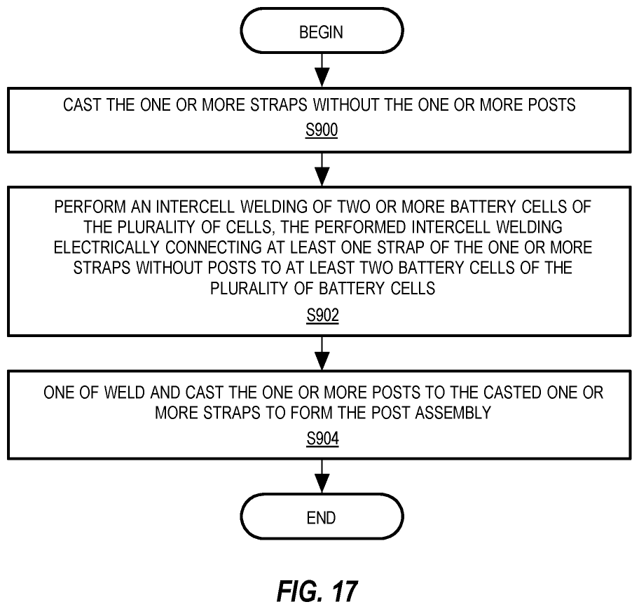

FIG. 17 shows another example assembly process (i.e., a method) of a battery 10 according to the principles of the present disclosure. The battery 10 includes a plurality of battery cells 14 and a post assembly 15. The post assembly 15 comprises one or more straps 16 and one or more posts 18. The method includes one or more of casting (Block S900) the one or more straps 16 without the one or more posts 18, performing (Block S902) an intercell welding of two or more battery cells 14 of the plurality of battery cells 14, where the performed intercell welding electrically connects at least one strap 16 of the one or more straps 16 without posts 18 to at least two battery cells 14 of the plurality of battery cells 14, and one of welding and casting (Block S904) the one or more posts 18 to the casted one or more straps 16 to form the post assembly 15.

In some embodiments, the casting of the one or more straps 16 is performed using an overflow mold.

In some other embodiments, the casting of the one or more posts comprises lead casting the one or more posts 18.

In an embodiment, the welding of the one or more posts 18 is performed using rotary friction welding.

In another embodiment, the welding of the one or more posts 18 includes welding the one or more posts 18 using a resistance welding process.

In one or more embodiments, welding may include intercell (IC) welding, electrofusion (EF) welding, through the partition (TTP) welding, resistance welding, etc. In an embodiment, IC welding may refer to or comprise EF welding and/or TTP welding.

In some embodiments, one or more of the following steps are performed: enveloping of battery components such as battery cells 14, stacking battery components such as battery cells 14, inboxing the battery cells 14 and/or post assembly 15 in case 12, testing the height of posts 18, aligning posts, sealing first cover 20, second cover 30, third cover 36, and/or caps 38 to another battery component, testing terminal height and/or battery height, and performing leak tests.

In a nonlimiting example, post assembly 15 includes five posts 18 (e.g., mini-posts). The post assembly 15 is formed by casting the one or more straps without the one or more posts 18 and welding or casting the one or more posts 18 to the casted one or more straps 16. The post assembly 15 is later placed over the battery cells 14 which may have been previously placed in case 12 or prepared to be later placed in case 12. An intercell welding is performed where each one of the five posts 18 is coupled to (e.g., welded to) and/or electrically connected to a battery cell 14 and/or two or more battery cells 14 are interconnected via at least a portion of the post assembly 15. The first cover 20 is sealed to case 12, where at least a portion of the posts 18 protrudes out of first cover 20. Lead assembly 24 is connected to each protruding post 18 and connected to the BMS 26. That is, the BMS 26 is electrically connected to the battery cells 14 via post assembly 15 to perform at least one action associated with a parameter of the battery cells 14 such as measuring voltage of each battery cell 14.

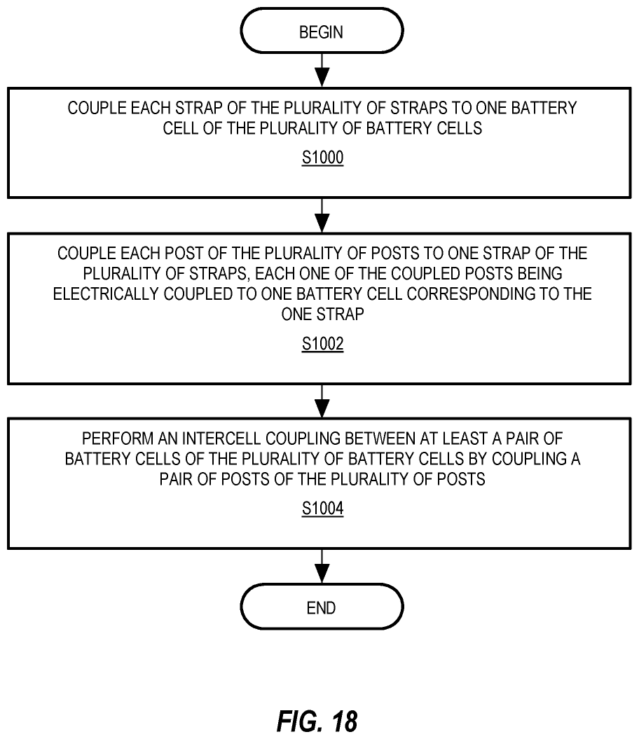

FIG. 18 shows another example battery assembly method. The battery has a plurality of battery cells 14, a plurality of straps 16, a plurality of posts 18. The method includes coupling (Block S1000) each strap 16 of the plurality of straps 16 to one battery cell 14 of the plurality of battery cells 14, coupling (Block S1002) each post 18 of the plurality of posts 18 to one strap 16 of the plurality of straps 16, where each one of the coupled posts 18 is electrically coupled to one battery cell 14 corresponding to the one strap 16, and performing (Block S1004) an intercell coupling between at least a pair of battery cells 14 of the plurality of battery cells 14 by coupling a pair of posts 18 of the plurality of posts 18.

In some embodiments, the coupling of each strap 16 of the plurality of straps 16 to one battery cell 14 of the plurality of battery cells 14 is performed using a first COS process.

In some other embodiments, the coupling of each post of the plurality of posts to one strap of the plurality of straps is performed using a second COS process.

In some embodiments, the method further includes, prior to coupling each strap 16 to one battery cell 14 and coupling each post 18 to one strap 16, one of stuffing the battery cells 14 and pre-stuffing the battery cells 14.

In some other embodiments, the performing of the intercell coupling includes welding the pair of posts 18.

In some embodiments, the performing of the intercell coupling includes electrically coupling the pair of posts 18 to one strap 16 of the plurality of straps 16.

In some other embodiments, the performing of the intercell coupling includes coupling one strap 16 of the plurality of straps to the pair of battery cells 14.

In some embodiments, the battery 10 includes at least an intercell connector 204, and the performing of the intercell coupling includes coupling the intercell connector 204 to the pair of posts 18.

In some other embodiments, the battery further includes a cover 20, 200. The cover 20, 200 includes a pair of openings 202 electrically coupled via the intercell connector 204. The method further includes inserting the pair of posts 18 through the pair of openings 202, where the inserted pair of posts 118 is electrically coupled via the intercell connector 204.

In some embodiments, the battery 10 is a lead acid battery.

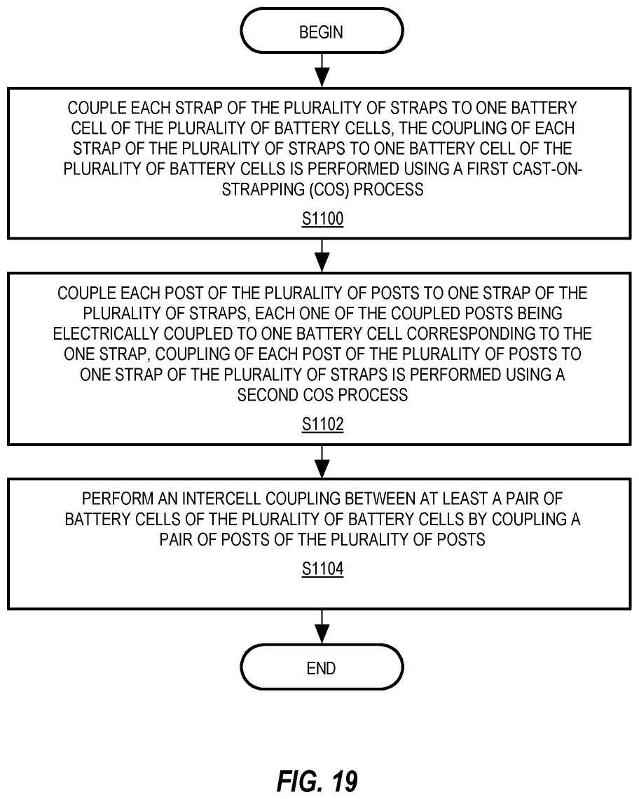

FIG. 19 shows an example battery assembly method. The battery has a plurality of battery cells 14, a plurality of straps 16, a plurality of posts 18. The method includes coupling (Block S1100) each strap 16 of the plurality of straps 16 to one battery cell 14 of the plurality of battery cells 14. The coupling of each strap 16 of the plurality of straps 16 to one battery cell 14 of the plurality of battery cells 14 is performed using a first COS process. The method further includes coupling (Block S1102) each post 18 of the plurality of posts 18 to one strap 16 of the plurality of straps 16, where each one of the coupled posts 18 is electrically coupled to one battery cell 14 corresponding to the one strap 16. The coupling of each post of the plurality of posts to one strap of the plurality of straps is performed using a second COS process. Further, the method includes performing (Block S1104) an intercell coupling between at least a pair of battery cells 14 of the plurality of battery cells 14 by coupling a pair of posts 18 of the plurality of posts 18.

In some embodiments, the method further includes, prior to coupling each strap 16 to one battery cell 14 and coupling each post 18 to one strap 16, one of stuffing the battery cells 14 and pre-stuffing the battery cells 14.

In some other embodiments, the performing of the intercell coupling includes welding the pair of posts 18.

In some embodiments, the performing of the intercell coupling includes electrically coupling the pair of posts 18 to one strap 16 of the plurality of straps 16.

In some other embodiments, the performing of the intercell coupling includes coupling one strap 16 of the plurality of straps to the pair of battery cells 14.

In some embodiments, the battery 10 includes at least an intercell connector 204, and the performing of the intercell coupling includes coupling the intercell connector 204 to the pair of posts 18.

In some other embodiments, the battery further includes a cover 20, 200. The cover 20, 200 includes a pair of openings 202 electrically coupled via the intercell connector 204. The method further includes inserting the pair of posts 18 through the pair of openings 202, where the inserted pair of posts 118 is electrically coupled via the intercell connector 204.

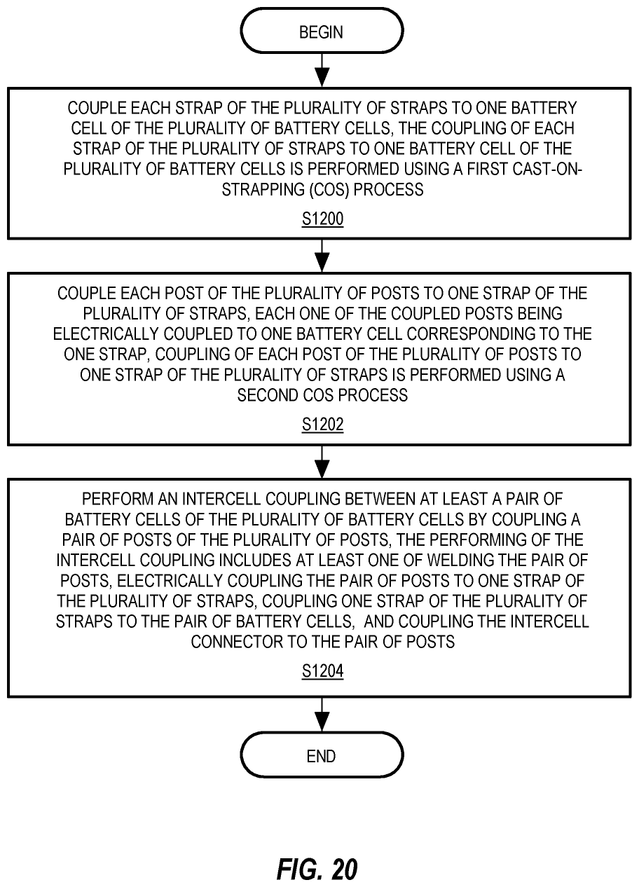

FIG. 20 shows an example battery assembly method. The battery has a plurality of battery cells 14, a plurality of straps 16, a plurality of posts 18. The method includes coupling (Block S1100) each strap 16 of the plurality of straps 16 to one battery cell 14 of the plurality of battery cells 14. The coupling of each strap 16 of the plurality of straps 16 to one battery cell 14 of the plurality of battery cells 14 is performed using a first COS process. The method further includes coupling (Block S1102) each post 18 of the plurality of posts 18 to one strap 16 of the plurality of straps 16, where each one of the coupled posts 18 is electrically coupled to one battery cell 14 corresponding to the one strap 16. The coupling of each post of the plurality of posts to one strap of the plurality of straps is performed using a second COS process. Further, the method includes performing (Block S1204) an intercell coupling between at least a pair of battery cells 14 of the plurality of battery cells 14 by coupling a pair of posts 18 of the plurality of posts 18. The performing of the intercell coupling includes at least one of welding the pair of posts 18, electrically coupling the pair of posts 18 to one strap 16 of the plurality of straps 16, coupling one strap 16 of the plurality of straps 16 to the pair of battery cells 14, and coupling the intercell connector 204 to the pair of posts 18.

In some embodiments, the method further includes, prior to coupling each strap 16 to one battery cell 14 and coupling each post 18 to one strap 16, one of stuffing the battery cells 14 and pre-stuffing the battery cells 14.

In some other embodiments, the battery 10 further includes a cover 20, 200. The cover 20, 200 includes a pair of openings 202 electrically coupled via the intercell connector 204. The method further includes inserting the pair of posts 18 through the pair of openings 202, the inserted pair of posts 18 being electrically coupled via the intercell connector 204.

One or more embodiments of the present disclosure advantageously provide an arrangement for providing individual posts, e.g., posts 18, to individual cells 14 within a battery 10, to facilitate the ability to monitor each individual cell 14 of the battery 10, such as by coupling a lead assembly 24 to the posts 18 to allow electrical connectivity from each battery cell 14 (via corresponding posts 18), to a BMS 26. One or more embodiments are beneficial at least because an intercell connection is provided. The intercell connection may be established by an intercell connector 204 (external to battery cells 14), which connects the bushings 42 and/or posts 18 from two or more battery cells. In some other embodiments, the intercell connection may be integrated with the cover 20, 200.

The following is a list of nonlimiting example embodiments.

A1. A method for assembling a battery, the battery having one or more battery cells, the method comprising at least one of:
pre-stuffing the one or more battery cells;
performing a first cast-on-strapping (COS) to one or more battery components; and
performing a second cast-on-strapping (COS) to one or more other battery components, at least one of the first COS and the second COS forming at least an inter-cell connection between the pre-stuffed one or more battery cells.

A2. The method of Embodiment A1, wherein any one of the first COS and the second COS includes casting straps to the pre-stuffed one or more battery cells.

A3. The method of any one of Embodiments A1 and A2, the method further includes performing enveloping and/or stacking of battery cells to pre-stuff the one or more battery cells.

A4. The method of any one of Embodiments A1-A3, wherein the pre-stuffing is performed using a pre-stuffing tool.

A5. The method of any one of Embodiments A1-A4, wherein the first COS is performed using jigboxes for containers with books.

A6. The method of any one of Embodiments A1-A5, wherein the second COS is performed using a mold.

A7. The method of any one of Embodiments A1-A6, wherein the battery further includes a post assembly and one or more posts, the one or more battery components associated with the first COS include the post assembly and the one or more battery cells, and the one or more other battery components associated with the second COS include the one or more posts and/or the post assembly, the first COS and the second COS electrically connecting at least one of the post assembly and the one or more posts to the one or more battery cells.

A8. The method of Embodiment A7, wherein the method further includes performing inter-cell welding at least by welding the post assembly to one or more battery cells.

A9. The method of Embodiment A8, wherein the inter-cell welding is performed using weld jaws.

A10. The method of o any one of Embodiments A7-A9, wherein the battery further includes a lead assembly and a battery management system configured to determine and/or measure at least one battery cell parameter, and the method further includes:
electrically coupling the one or more posts to the lead assembly; and
electrically coupling the lead assembly to the battery management system.

A11. The method of any one of Embodiments A1-A10, wherein the battery further includes a first cover and a case, and the method includes coupling the first cover to the case, the coupling including performing one of tungsten inert gas (TIG) welding and flame welding the first cover to the case.

B1. A method for assembling a battery, the battery comprising an inter-cell busbar, at least one post, a plurality of battery cells, the method comprising at least one of:
pre-stuffing at least one battery cell of the plurality of battery cells; and
performing an inter-cell connection of at least a first battery cell and a second battery cell of the plurality of battery cells, the performed inter-cell connection including at least one of:
   coupling the first battery cell to the second battery cell via the inter-cell busbar; and
   coupling the at least one post to at least one of the inter-cell busbar, the first battery cell, and the second battery cell.

B2. The method of Embodiment B 1, wherein the battery further comprises a first battery cell connector and a second battery cell connector, and each one of the first battery cell and the second battery cell comprise a plurality of electrodes, the method further comprising:
coupling the first battery cell connector to the plurality of electrodes of the first battery cell; and
coupling the second battery cell connector to the plurality of electrodes of the second battery cell.

B3. The method of Embodiment B2, wherein the method further includes:
coupling the first battery cell connector to the inter-cell busbar; and
coupling the second battery cell connector to the inter-cell busbar.

B4. The method of any one of Embodiments B2 and B3, wherein battery further includes a first busbar fastener and a second busbar fastener, and the method further includes:
coupling the first busbar fastener to the inter-cell busbar and the first battery cell connector at least by fastening the first busbar fastener to the first battery cell connector; and
coupling the second busbar fastener to the inter-cell busbar and second battery cell connector at least by fastening the second busbar fastener to the second battery cell connector, the fastening of the first and second busbar fasteners securing the inter-cell busbar to each one of the first and second battery cells and forming a connection between the first and second battery cells.

B5. The method of any one of Embodiments B2-B4, wherein coupling the at least one post to at least one of the inter-cell busbar, the first battery cell, and the second battery cell further includes:
coupling the at least one post to at least one of the first battery cell connector and a second battery cell connector.

B6. The method of any one of Embodiments B1-B5, wherein the battery further includes a cover comprising at least one bushing electrically coupled to the inter-cell busbar, and the method further includes:
coupling the at least one post to the at least one bushing at least to perform the inter-cell connection.

B7. The method of any one of Embodiments B1-B6, wherein the battery is a lead-acid battery, and the at least one post is a mini-post.

C1. A method for assembling a battery, the battery comprising a first battery cell, a second battery cell, a first strap and a first post contiguous with the first strap, and a second strap and second post contiguous with the second strap, the method comprising one or more of:
casting the first strap with the contiguous first post to the first battery cell to couple the first strap to the first battery cell;
casting the second strap with the contiguous second post to the second battery cell to couple the second strap to the second battery cell; and
performing an intercell welding of the first and second battery cells, the performed intercell welding electrically connecting one or both of the first strap and the first post to one or both of the second strap and the second post.

C2. The method of Embodiment C1, wherein the casting of the first and second straps is performed using an overflow mold having a predetermined pitch.

C3. The method of any one of Embodiments C1 and C2, wherein the battery further comprises a case, and the casting of the first and second straps is performed using a jig box for the case.

C4. The method of any one of Embodiments C1-C3, wherein the method further includes:
stuffing the plurality of battery cells.

D1. A method for assembling a battery, the battery comprising a plurality of battery cells and a post assembly, the post assembly comprising one or more straps and one or more posts, the method comprising one or more of:
casting the one or more straps without the one or more posts;
performing an intercell welding of two or more battery cells of the plurality of cells, the performed intercell welding electrically connecting at least one strap of the one or more straps without posts to at least two battery cells of the plurality of battery cells; and
one of welding and casting the one or more posts to the casted one or more straps to form the post assembly.

D2. The method of Embodiment D1, wherein the casting of the one or more straps is performed using an overflow mold.

D3. The method of any one of Embodiments D1 and D2, wherein the casting of the one or more posts comprises lead casting the one or more posts.

D4. The method of any one of Embodiments D1-D3, wherein the welding of the one or more posts is performed using rotary friction welding.

D5. The method of any one of Embodiments D1-D4, wherein the welding of the one or more posts includes:
welding the one or more posts using a resistance welding process.

It will be appreciated by persons skilled in the art that the present embodiments may be not limited to what may have been particularly shown and described. In addition, unless mention was made above to the contrary, it should be noted that all of the accompanying drawings may be not to scale. A variety of modifications and variations may be possible in light of the above teachings and following claims.

1. A method for assembling a battery, the battery having a plurality of battery cells, a plurality of straps, and a plurality of posts, the method comprising:
coupling each strap of the plurality of straps to one battery cell of the plurality of battery cells;
coupling each post of the plurality of posts to one strap of the plurality of straps, each one of the coupled posts being electrically coupled to one battery cell corresponding to the one strap; and
performing an intercell coupling between at least a pair of battery cells of the plurality of battery cells by coupling a pair of posts of the plurality of posts.

2. The method of claim 1, wherein the coupling of each strap of the plurality of straps to one battery cell of the plurality of battery cells is performed using a first cast-on-strapping, COS, process.

3. The method of claim 1, wherein the coupling of each post of the plurality of posts to one strap of the plurality of straps is performed using a second COS process.

4. The method of claim 1, wherein the method further includes, prior to coupling each strap to one battery cell and coupling each post to one strap, one of:
stuffing the battery cells; and
pre-stuffing the battery cells.

5. The method of claim 1, wherein the performing of the intercell coupling includes:
welding the pair of posts.

6. The method of claim 1, wherein the performing of the intercell coupling includes:
electrically coupling the pair of posts to one strap of the plurality of straps.

7. The method of claim 1, wherein the performing of the intercell coupling includes:
coupling one strap of the plurality of straps to the pair of battery cells.

8. The method of claim 1, wherein the battery includes at least an intercell connector, and the performing of the intercell coupling includes:
coupling the intercell connector to the pair of posts.

9. The method of claim 8, wherein the battery further includes a cover, the cover including a pair of openings electrically coupled via the intercell connector, and the method further includes:
inserting the pair of posts through the pair of openings, the inserted pair of posts being electrically coupled via the intercell connector.

10. The method of claim 1, wherein the battery is a lead acid battery.

11. A method for assembling a battery, the battery having a plurality of battery cells, a plurality of straps, and a plurality of posts, the method comprising:
coupling each strap of the plurality of straps to one battery cell of the plurality of battery cells, the coupling of each strap of the plurality of straps to one battery cell of the plurality of battery cells is performed using a first cast-on-strapping, COS, process;
coupling each post of the plurality of posts to one strap of the plurality of straps, each one of the coupled posts being electrically coupled to one battery cell corresponding to the one strap, coupling of each post of the plurality of posts to one strap of the plurality of straps is performed using a second COS process; and
performing an intercell coupling between at least a pair of battery cells of the plurality of battery cells by coupling a pair of posts of the plurality of posts.

12. The method of claim 11, wherein the method further includes, prior to coupling each strap to one battery cell and coupling each post to one strap, one of:
stuffing the battery cells; and
pre-stuffing the battery cells.

13. The method of claim 11, wherein the performing of the intercell coupling includes:
welding the pair of posts.

14. The method of claim 11, wherein the performing of the intercell coupling includes:
electrically coupling the pair of posts to one strap of the plurality of straps.

15. The method of claim 11, wherein the performing of the intercell coupling includes:
coupling one strap of the plurality of straps to the pair of battery cells.

16. The method of claim 11, wherein the battery includes at least an intercell connector, and the performing of the intercell coupling includes:
coupling the intercell connector to the pair of posts.

17. The method of claim 16, wherein the battery further includes a cover, the cover including a pair of openings electrically coupled via the intercell connector, and the method further includes:
inserting the pair of posts through the pair of openings, the inserted pair of posts being electrically coupled via the intercell connector.

18. A method for assembling a battery, the battery having a plurality of battery cells, a plurality of straps, a plurality of posts, and an intercell connector, the method comprising:
coupling each strap of the plurality of straps to one battery cell of the plurality of battery cells, the coupling of each strap of the plurality of straps to one battery cell of the plurality of battery cells is performed using a first cast-on-strapping, COS, process;
coupling each post of the plurality of posts to one strap of the plurality of straps, each one of the coupled posts being electrically coupled to one battery cell corresponding to the one strap, coupling of each post of the plurality of posts to one strap of the plurality of straps is performed using a second COS process; and
performing an intercell coupling between at least a pair of battery cells of the plurality of battery cells by coupling a pair of posts of the plurality of posts, the performing of the intercell coupling includes at least one of:
welding the pair of posts;
electrically coupling the pair of posts to one strap of the plurality of straps;
coupling one strap of the plurality of straps to the pair of battery cells; and
coupling the intercell connector to the pair of posts.

19. The method of claim 18, wherein the method further includes, prior to coupling each strap to one battery cell and coupling each post to one strap, one of:
stuffing the battery cells; and
pre-stuffing the battery cells.

20. The method of claim 18, wherein the battery further includes a cover, the cover including a pair of openings electrically coupled via the intercell connector, and the method further includes:
inserting the pair of posts through the pair of openings, the inserted pair of posts being electrically coupled via the intercell connector.
